(19) United States
(12) Patent Application Publication
(10) Pub. No.: US 2026/0015887 A1
(43) Pub. Date: Jan. 15, 2026

(54) ELECTRONIC LOCK SYSTEMS FOR BI-SWING DOORS

(71) Applicant: David Edmond Dudley, Oregon City, OR (US)

(72) Inventor: David Edmond Dudley, Oregon City, OR (US)

(21) Appl. No.: 18/769,144

(22) Filed: Jul. 10, 2024

(51) Int. Cl. E05B 47/00; E05B 65/06

(52) U.S. Cl. CPC E05B 47/0004; E05B 65/06; E05B 2047/0016

(57) ABSTRACT

Electronic lock systems including a frame and an electronic lock mechanism operatively mounted to the frame. The electronic lock mechanism includes an arm and a linear actuator. The arm moves between a door lock position engaging a door and a door release position spaced from the door. The linear actuator moves between a system lock position and a system release position. In the system release position, the linear actuator presses against the arm to move the arm to the door release position. In some examples, the electronic lock system includes a catch disposed proximate to the arm. The catch is configured to selectively engage the arm to restrict the arm from moving and to selectively allow the arm to move.

### BACKGROUND

The present disclosure relates generally to door locking mechanisms. In particular, electronic lock systems for bi-swing doors are described.

Bi-swing impact doors, also known as double swinging traffic doors, are commonly installed in warehouses, retail establishments, and other commercial buildings. Bi-swing doors employ two relatively large doors mounted to opposite lateral sides of a doorframe. Each door swings from its respective lateral side of the doorframe via hinges.

The bi-swing doors are supported in close proximity to each other at the middle of the doorframe. Typically, there is not a vertical post disposed between the bi-swing doors at the center of the doorframe. The lack of a central vertical post makes locking bi-swing doors a unique challenge.

Locking bi-swing impact doors is important, however, as it is often necessary to prevent unauthorized personnel from passing through the bi-swing doors. For example, a business may wish to restrict customers or other unauthorized personnel from entering a warehouse area in retail stores though a bi-swing door used by authorized store employees. Theft, accidents, and other undesirable events can occur when people intentionally or accidently pass through bi-swing doors to restricted areas without authorization.

Certain systems for locking bi-swing doors exist, but they are not entirely satisfactory. For example, some currently known systems require a magnetic lock device in combination with a solenoid to function. It would be desirable if a locking system for bi-swing doors did not require a magnetic lock device and instead was effective with just a solenoid.

Thus, there exists a need for novel locking systems that improve upon and advance the design of known locking mechanisms for bi-swing doors. Examples of new and useful locking systems for bi-swing doors relevant to the needs existing in the field are discussed below.

Examples of references relevant to locking systems for bi-swing doors include the following U.S. and international patent references: U.S. Pat. No. 8,807,605B1; U.S. Pat. No. 8,186,729; U.S. Pat. No. 5,492,382A; U.S. Pat. No. 6,010,168A; U.S. Pat. No. 10,704,293B2; and WO2021089973A1. The complete disclosures of the above patents and patent applications are herein incorporated by reference for all purposes.

### SUMMARY

The present disclosure is directed to electronic lock systems including a frame and an electronic lock mechanism operatively mounted to the frame. The electronic lock mechanism includes an arm and a linear actuator. The arm moves between a door lock position engaging a door and a door release position spaced from the door.

The linear actuator moves between a system lock position and a system release position. In the system release position, the linear actuator presses against the arm to move the arm to the door release position.

In some examples, the electronic lock system includes a catch disposed proximate to the arm. The catch is configured to selectively engage the arm to restrict the arm from moving and to selectively allow the arm to move.

### BRIEF DESCRIPTION OF THE DRAWINGS

FIG. 1 is a perspective view of a first embodiment of an electronic lock system.

FIG. 2 is a cross-sectional view of the electronic lock system shown in FIG. 1 with an arm in a door lock position, a catch in an arm lock position, and a linear actuator in a system lock position.

FIG. 3 is a cross-sectional view of the electronic lock system shown in FIG. 1 with the arm in the door lock position, the catch in an arm release position, and the linear actuator in an intermediate position between the system lock position and a system release position.

FIG. 4 is a cross-sectional view of the electronic lock system shown in FIG. 1 with the arm in a door release position, the catch in the arm release position, and a linear actuator in the system release position.

FIG. 5 is a perspective view of the catch of the electronic lock system shown in FIG. 1.

FIG. 6 is a cross-sectional view of a second embodiment of an electronic lock system with a spring biasing a catch towards an arm release position.

FIG. 7 is a top plan view of a portion of a third embodiment of an electronic lock system with an extension spring disposed between an arm and a linear actuator.

### DETAILED DESCRIPTION

The disclosed electronic lock systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various electronic lock systems are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### DEFINITIONS

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

“Communicatively coupled” means that an electronic device exchanges information with another electronic device, either wirelessly or with a wire-based connector, whether directly or indirectly through a communication network.

“Controllably coupled” means that an electronic device controls operation of another electronic device.

### Electronic Lock Systems for Bi-Swing Doors

With reference to the figures, electronic lock systems for bi-swing doors will now be described. The electronic lock systems discussed herein function to selectively lock and release doors. The electronic lock systems are particularly well-suited to selectively locking and releasing bi-swing doors, also known as bi-swing impact doors.

The reader will appreciate from the figures and description below that the presently disclosed electronic lock systems address many of the shortcomings of conventional door locking mechanisms. For example, the novel electronic lock systems do not require a magnetic lock device in combination with a separate solenoid to function effectively for bi-swing doors. Desirably, the novel electronic lock systems are effective to selectively lock bi-swing doors without a magnetic locking device separate from a linear actuator.

### Contextual Details

Ancillary features relevant to the electronic lock systems described herein will first be described to provide context and to aid discussing the electronic lock systems.

### Bi-Swing Doors

The novel electronic lock systems discussed herein are used to selectively lock and release doors, including bi-swing doors. This document focuses on bi-swing door examples for simplicity and to provide concrete examples. However, the reader should understand that the novel electronic lock systems described in this document may be used to selectively lock other types of doors beyond bi-swing doors.

Bi-swing doors generally employ two relatively large doors mounted to opposite lateral sides of a doorframe. Each door swings from its respective lateral side of the doorframe via hinges. The bi-swing doors are supported in close proximity to each other at the middle of the doorframe. Typically, there is not a vertical post disposed between the bi-swing doors at the center of the doorframe.

The novel electronic lock systems selectively restrict the bi-swing doors from opening by selectively engaging the tops of each door. However, the reader should understand that the novel electronic lock systems may engage other sides of a door to restrict it from opening. For example, the novel electronic lock systems may selectively engage bottom, front, back, left, or right sides of the doors.

### Controllers

The novel electronic lock systems described below are typically controllably coupled to a controller to selectively activate them. In the examples below, the electronic lock systems are controllably coupled to a controller via wires. However, the system and controller may be controllably coupled via wireless communication with any currently known or later developed wireless communication protocol.

The controller may be any currently known or later developed type of controller for activating a door locking system. Suitable controllers include buttons, sliders, wall switches, multi-input controls, touchscreens, smart devices, and computers. Proximity sensors, motion sensors, optical tripwires, and the like may be used to control activation of the electronic lock systems described herein.

### Electronic Lock System Embodiment One

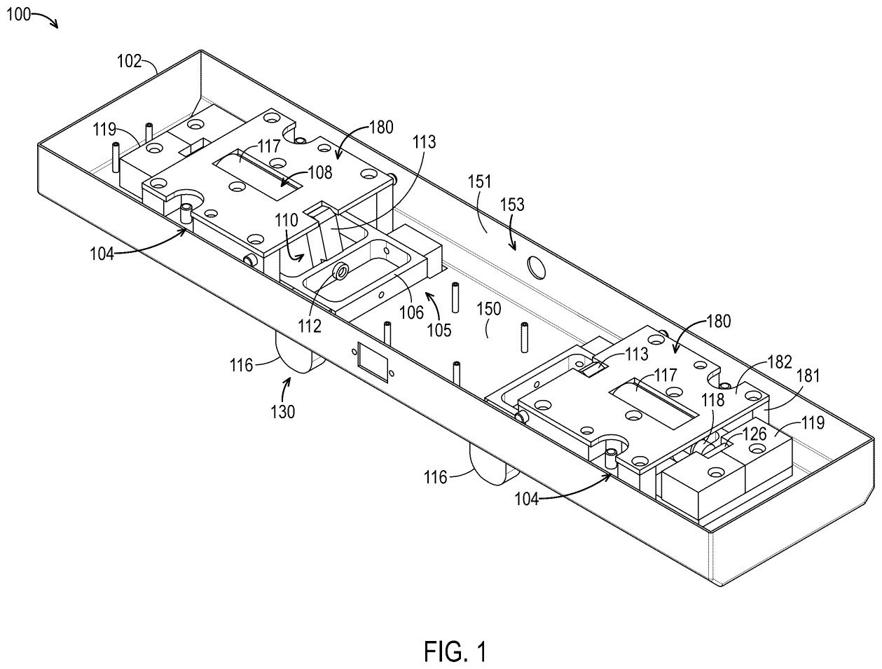

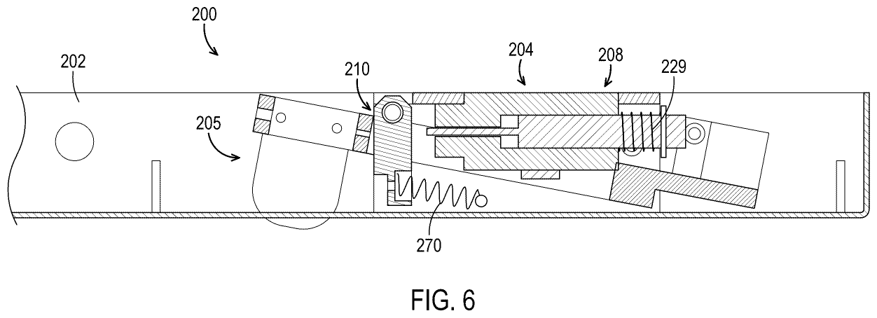

With reference to FIGS. 1-5, a first example of an electronic lock system, electronic lock system 100, will now be described. A second example of an electronic lock system, electronic lock system 200, is depicted in FIG. 6 and described further below.

As shown in FIGS. 1-4, electronic lock system 100 includes a housing 102, two frames 180, and two electronic lock mechanisms 104. In some examples, the electronic lock system does not include one or more features included in electronic lock system 100. For example, some electronic lock system examples do not include a housing and/or include just a single electronic lock mechanism. In other examples, the electronic lock system includes additional or alternative features, such as controllers for activating and deactivating the electronic lock mechanisms.

For example, the electronic lock system may include a motion sensor on a warehouse side of doors selectively locked by the electronic lock mechanism. The motion sensor may be configured to allow free egress through the doors. On a retail side of the doors, access may be restricted to authorized personnel either with a keypad, employee badge, cell phone or other Bluetooth device, or biometric input. The electronic lock system may include sensors that detect the door position and to re-lock the doors after a pre-set amount of time. The system may also include an alarm that sounds if the doors are propped open for a certain amount of time.

Electronic lock system 100 functions to selectively restrict a door from moving. Expressed another way, electronic lock system 100 serves to selectively lock and release doors. Electronic lock system 100 is specially configured to selectively lock and release bi-swing doors, also known as bi-swing impact doors.

In the example shown in FIGS. 1-5, electronic lock system 100 is configured to mount above a bi-swing door. In other examples, the electronic lock system is configured to mount below the door it selectively locks.

The size and shape of the electronic lock system will vary in different examples. For example, in applications where a door is relatively large or small, the electronic lock system may be larger or smaller, respectively, than depicted in the figures. The electronic lock system may be larger or smaller irrespective of the size of the doors selectively locked with the electronic lock system.

In the example shown in FIGS. 1-5, electronic lock system 100 is configured with two electronic lock mechanisms 104 mounted within a single housing 102. However, some electronic lock system examples include a single electronic lock mechanism within a single housing. Such examples may employ two electronic lock mechanisms in separate housings to selectively lock bi-swing doors: one mechanism and housing combination per bi-swing door selectively locked.

### Housing

Housing 102 functions to contain and support electronic lock mechanisms 104 and frames 180. Housing 102 also protects and aesthetically minimizes electronic lock mechanisms 104 and frames 180. Further, housing 102 facilitates mounting electronic lock system 100 to a structure, such as a doorframe or ceiling.

Not all examples of the electronic lock system include a housing. In some examples, the electronic lock mechanisms mount directly to a structure and are not contained within a housing.

As shown in FIGS. 1-4, housing 102 includes a floor 150 and housing sidewalls 151. Housing sidewalls 151 extend transverse to floor 150 around a periphery of floor 150. Housing sidewalls 151 and floor 150 cooperate to define an interior volume 153. Electronic lock mechanisms 104 and frames 180 are mounted to housing 102 in interior volume 153 of housing 102.

In the present example, housing 102 is formed from metal. However, the housing may be formed from any material or materials suitable for containing and supporting the electronic lock mechanisms. Suitable materials include metals, polymers, wood, and composite materials.

As shown in FIGS. 1-4, housing 102 is sized to house two electronic lock mechanisms 104. In other examples, the housing is larger or smaller than depicted in FIGS. 1-4. For example, the housing may be sized to accommodate a single electronic lock mechanism.

The reader can see in FIG. 1 that housing 102 is rectangular. However, the housing may be any shape suitable for housing one or more electronic lock mechanisms.

### Frames

Frames 180 function to enclose and support components of electronic lock mechanisms 104. In particular, as explained in more detail below, frames 180 support pivot shafts of electronic lock mechanisms 104.

As shown in FIG. 1, frames 180 are supported inside interior volume 153 of housing 102 on floor 150. As further shown in FIG. 1, electronic lock mechanisms 104 are disposed inside frames 180.

Frames 180 include frame sidewalls 181, a roof 182, an arm bearing shaft 123, and a catch bearing shaft 115. Frame sidewalls 181 are spaced apart from each other. Roof 182 extends from one frame sidewall to the other across the space between them and mounts to frame sidewalls 181 with mechanical fasteners. Roof 182 and frame sidewalls 181 define a frame interior volume in which an electronic lock mechanism 104 is disposed.

Arm bearing shaft 123 extends from frame sidewalls 181 into the frame interior volume of a given frame 180. Arm bearing shaft 123 pivotally supports an arm 105 of electronic lock mechanism 104.

Similarly, catch bearing shaft 115 extends from frame sidewalls 111 into the frame interior volume of a given frame 180. Catch bearing shaft 115 pivotally supports a catch 110 of electronic lock mechanism 104.

In the present example, frames 180 are formed from aluminum. However, the frames may be formed from any material sufficiently rigid to support bearing shafts and components mounted to the bearing shafts.

### Electronic Lock Mechanism

Electronic lock mechanisms 104 function to selectively restrict movement of doors disposed proximate to them. In many instances, electronic lock mechanisms 104 serve to selectively lock and release bi-swing doors.

As shown in FIGS. 1-4, each electronic lock mechanism 104 is configured the same. Thus, the discussion below will describe one electronic lock mechanism in detail and the reader should understand that the description applies to both electronic lock mechanisms 104 depicted in FIGS. 1-4.

As shown in FIGS. 1-4, electronic lock mechanisms 104 are mounted to frame 180 in the interior volume of housing 102 and in the interior volume of frames 180. In some examples, the electronic lock mechanisms mount directly to a structure, such as a doorframe or ceiling, and are not mounted to a housing.

In the example shown in FIGS. 1-5, electronic lock mechanisms 104 include an arm 105, a catch 110, and a linear actuator 108. The components of electronic lock mechanism 104 are described in detail below.

### Arm

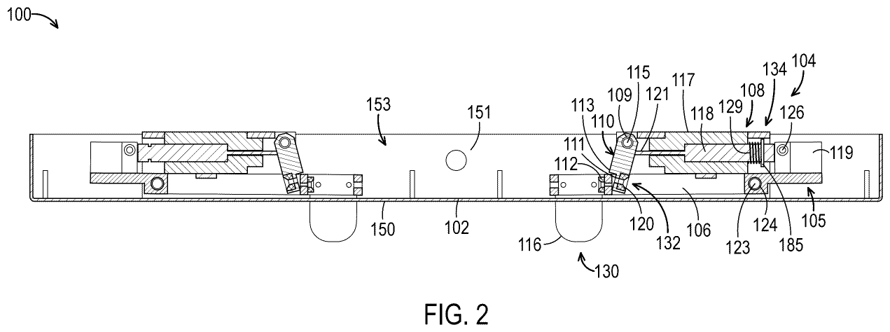

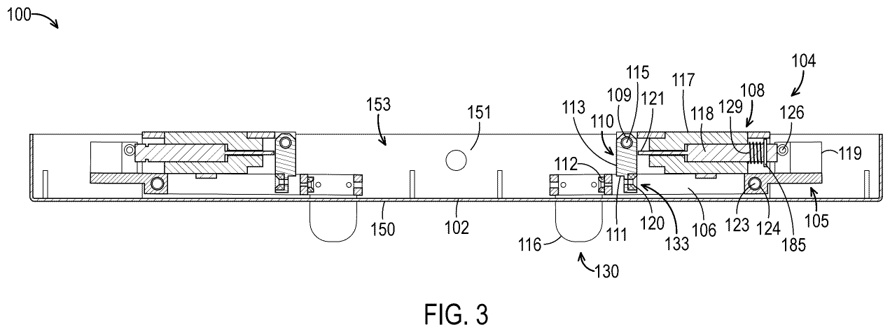

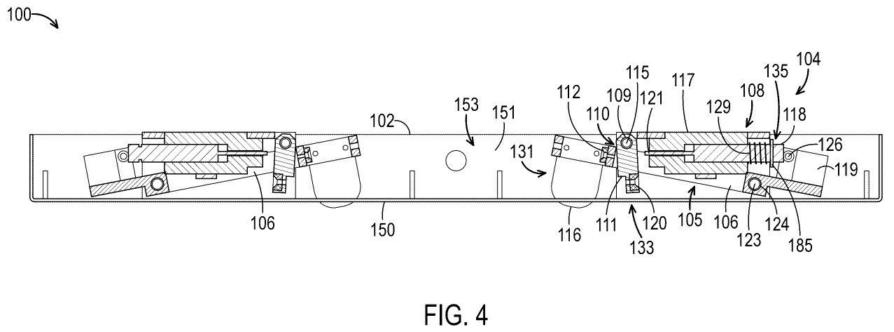

Arm 105 functions to selectively engage a door to restrict the door from moving. As shown in FIGS. 2 and 3, arm 105 selectively extends beyond housing 102 to enable arm 105 to engage a door below housing 102. As shown in FIG. 4, arm 105 selectively retracts substantially within housing 102 to enable arm 105 to disengage from a door below housing 102.

As shown in FIGS. 1-4, arm 105 is pivotally mounted to frame 180 proximate catch 110 on one end and proximate linear actuator 108 on an opposite end. However, the arm may be mounted to translate relative to the frame instead of pivoting relative to the frame in other examples.

As shown in FIGS. 2-4, arm 105 is configured to pivot between a door lock position 130 and a door release position 131. In door lock position 130 shown in FIGS. 1-3, arm 105 extends beyond housing 102 to enable engaging a door to restrict the door from moving. In door release position 131 shown in FIG. 4, arm 105 is substantially retracted into housing 102 and spaced from a door below housing 102 to allow the door to move.

The size and shape of the arm may vary in different examples. The arm may be any type of structural member or assembly suitable for selectively moving relative to the housing to engage and release a door.

With reference to FIGS. 1-4, the reader can see that arm 105 includes a platform 106, doorstops 116, an arm magnet 112, an engagement member 126, and a counterweight 119. In some examples, the arm includes fewer, additional, or alternative components. For example, FIG. 6 shows an example of an arm 205 without an arm magnet.

### Platform

Platform 106 supports doorstops 116, arm magnet 112, engagement member 126, and counterweight 119. Platform 106 also pivotally couples arm 105 to frame 180.

In particular, platform 106 defines an arm bearing port 124 complementarily configured with arm bearing shaft 123 of frame 180. Arm bearing port 124 receives arm bearing shaft 123 and enables platform 106 to pivot relative to arm bearing shaft 123. Arm bearing port 124 is defined at a medial position of platform 106 between counterweight 119 and doorstops 116.

### Doorstops

Doorstops 116 function to engage a door when arm 105 is in door lock position 130. As shown in FIGS. 1-4, doorstops 116 are mounted to platform 106 at an end of platform 106 opposite an end of platform 106 supporting counterweight 119. Arm bearing port 124 is disposed between doorstops 116 and counterweight 119, and thus, platform 106 pivots about an axis defined by arm bearing shaft 123 between doorstops 116 and counterweight 119.

The reader can see in FIGS. 1-3 that doorstops 116 extend beyond floor 150 of housing 102 in door lock position 130. Doorstops 116 extending beyond floor 150 enables them to engage and thereby restrict movement of a door disposed below floor 150. In some examples, the doorstops are complementarily configured with recesses formed in the door and insert into the door recesses. The doorstops inserting to the door recesses restricts the door from moving via lateral reaction forces between the doorstops and the door recesses.

With reference to FIG. 4, the reader can see that doorstops 116 retract into housing 102 in door release position 131. Doorstops 116 retracting into housing 102 spaces them from a door disposed below floor 150, which allows the door to move without restriction from doorstops 116.

The reader can see in FIG. 4 that doorstops 116 in the present example do not fully retract into housing 102 in door release position 131. Instead, a minor portion of doorstops 116 remains below floor 150, and a substantial portion of doorstops 116 is above floor 150. Doorstops 116 retracting into housing 102 sufficient for doorstops 116 to be spaced from a door disposed below floor 150 is effective to release the door. That is, it is not necessary for doorstops 116 to retract entirely into housing 102.

As shown in FIG. 1, arm 105 includes two doorstops 116 in the present example. However, some arm examples include a single doorstop. Other arm examples include more than two doorstops. The number of doorstops included in the arm may be selected to meet the needs of a given application and a given door configuration.

In the present example, doorstops 116 are formed from metal. In some examples, the doorstops have a metal core and a rubber outer layer. The doorstops may be formed from any suitable material, including metal, wood, a polymer, or a composite material.

### Arm Magnet

Arm magnet 112 interacts with catch 110 to bias catch 110 towards an arm release position 133. In particular, arm magnet 112 magnetically repels a catch magnet 120 to pivot catch 110 from arm lock position 132 into arm release position 133.

As shown in FIG. 2, arm magnet 112 and catch magnet 120 are disposed proximate each other when arm 105 is in door lock position 130 and catch 110 is in arm lock position 132. Arm magnet 112 and catch magnet 120 are arranged so that the same magnetic poles are oriented proximate to each other, which causes arm magnet 112 and catch magnet 120 to magnetically repel each other. When catch 110 is not held in arm lock position 132 by linear actuator 108 in a system lock 134 position, arm magnet 112 repels or biases catch 110 towards arm release position 133 shown in FIGS. 3 and 4.

The arm magnet may be any currently known or later developed type of magnet. Arm magnet 112 is a permanent magnet, but the arm magnet may be an electromagnet in other examples. The size, shape, and magnetic strength of the arm magnet may be selected to meet the needs of a given application.

### Engagement Member

Engagement member 126 interacts with linear actuator 108 to selectively move arm 105 between door lock position 130 and door release position 131. In particular, engagement member 126 magnetically and physically interacts with linear actuator 108. The engagement member is an optional feature not present in all examples of the arm.

Engagement member 126 is operatively mounted to platform 106. In particular, engagement member 126 is mounted to counterweight 119, which is supported on platform 106. The reader can see in FIGS. 1-4 that engagement member 126 is mounted proximate to linear actuator 108; in particular, proximate to a plunger 118 of linear actuator 108.

In the example shown in the figures, engagement member 126 is a steel member and is magnetically attractable. As described in more detail below, plunger 118 of linear actuator 108 is an electromagnet and emits a magnetic field when linear actuator 108 is electrically activated. When the magnetic field of plunger 118 is activated it magnetically couples engagement member 126 to plunger 118 when plunger 118 is sufficiently close to engagement member 126.

As shown in FIG. 2, plunger 118 is magnetically coupled to engagement member 126 when linear actuator 108 is in system lock position 134. The magnetic coupling between plunger 118 and engagement member 126 when linear actuator 108 is in system lock position 134 causes arm 105 to pivot to door lock position 130. Plunger 118 magnetically pulls engagement member 126 to cause arm 105 to pivot to door lock position 130 as plunger 118 moves away from engagement member 126 into system lock position 134.

In FIG. 4, the reader can see that plunger 118 presses against engagement member 126 when linear actuator 108 moves to system release position 135. Plunger 118 pressing against engagement member 126 causes arm 105 to pivot to door release position 131.

### Counterweight

Counterweight 119 functions to assist arm 105 pivoting to door release position 131. Counterweight 119 also functions to support engagement member 126 proximate to plunger 118. In examples where the arm does not include an engagement member, the counterweight may engage with the plunger in the same manner as the engagement member described above. Expressed another way, the counterweight may be the engagement member in some examples.

As shown in FIGS. 1-4, counterweight 119 is supported on platform 106. In particular, counterweight 119 is supported on platform 106 on a side of platform 106 opposite doorstops 116 with arm bearing port 124 and arm bearing shaft 123 disposed between counterweight 119 and doorstops 116. Thus, when counterweight 119 acts to pivot its side of arm 105 downward, doorstops 116 pivot upwards into door release position 131.

The size, shape, and weight of the counterweight may be selected to bias the arm towards the door release position to a desired extent. The strength of magnetic coupling between the linear actuator and the engagement member, which acts to selectively pull the arm into the door lock position, may be a factor in the weight and position on the platform (and the resulting moment arm) selected for the counterweight. The material of the counterweight may be any suitable material to provide a selected weight. In examples where the counterweight is intended to magnetically couple to the linear actuator, magnetically attractable materials are preferred for the counterweight.

### Catch

Catch 110 functions to selectively restrict arm 105 from moving. As shown in FIGS. 1-4, catch 110 is disposed proximate to arm 105 and to linear actuator 108. Catch 110 interacts with linear actuator 108 and arm magnet 112 to selectively move between arm lock position 132 and arm release position 133.

In arm lock position 132 shown in FIG. 2, catch 110 engages arm 105 in door lock position 130 to restrict arm 105 from moving towards door release position 131.

The reader can see in FIG. 2 that linear actuator 108 restricts catch 110 to arm lock position 132 by engaging catch 110 with a finger 121 extending beyond an actuator cylinder 117 of linear actuator 108. Finger 121 abuts and presses against catch 110 to restrict catch from pivoting to arm release position 133 when linear actuator 108 is in system lock position 134.

In arm release position 133 shown in FIGS. 3 and 4, catch 110 is spaced from arm 105, which allows arm 105 to move from door lock position 130 towards door release position 131. Evident from FIGS. 2-4 is that finger 121 begins retracting into actuator cylinder 117 to cease pressing catch 110 into arm lock position 132 when linear actuator 108 moves from system lock position 134 shown in FIG. 2 to system release position 135 shown in FIG. 4.

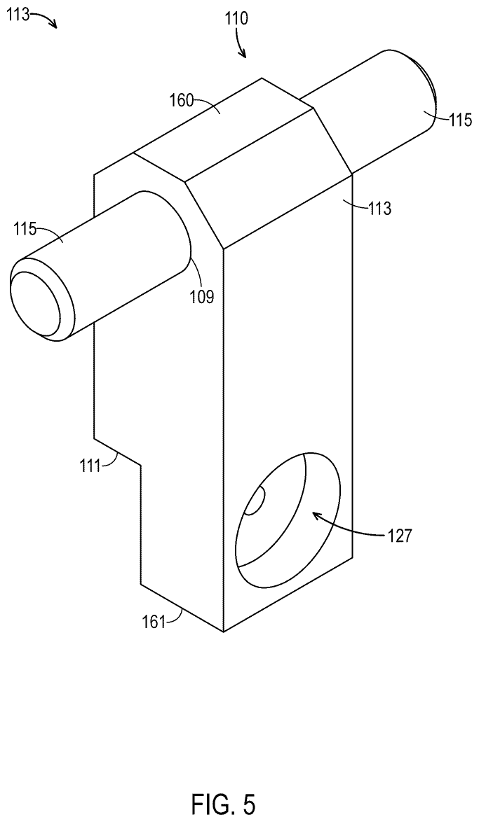

As shown in FIGS. 2-5, catch 110 includes a body 113 and a catch magnet 120. Body 113 is pivotally mounted to housing 102. As shown in FIG. 5, body 113 includes a first end 160 and a second end 161 opposite first end 160. As further shown in FIG. 5, body 113 defines a notch 111, a catch bearing port 109, and a cavity 127.

Notch 111 is complementarily configured with arm 105 to receive and abut arm 105. When notch 111 receives and abuts arm 105 in arm lock position 132, arm 105 is restricted from moving. The reader can see in FIGS. 2-5 that notch 111 is disposed proximate second end 161 of body 113 opposite catch bearing port 109, which is proximate to first end 160.

Catch bearing port 109 receives and slides around catch bearing shaft 115 of frame 180. Catch bearing port 109 and catch bearing shaft 115 enable catch 110 to pivotally mount to frame 180 and to pivot between arm lock position 132 and arm release position 133. The reader can see in FIGS. 2-4 that catch bearing port 109 is defined proximate first end 160 of body 113.

The arrangement of body 113 is such that the pivot arc of notch 111 is greater than the pivot arc of other portions of body 113 closer to catch bearing port 109. Finger 121 of linear actuator 108 selectively engages body 113 between bearing port 109 and second end 161 to restrict body 113 pivoting towards arm release position 133.

As shown in FIGS. 2-5, cavity 126 receives catch magnet 120 (not pictured in FIG. 5). Cavity 126 is defined in body 113 in a position proximate to arm magnet 112 when arm 105 is in door lock position 130 and catch 110 is in arm lock position 132. The size and shape of the cavity may vary to accommodate different arm magnets.

In addition to physically interacting by selectively abutting each other, catch 110 and arm 105 are complementarily configured to magnetically interact. As shown in FIGS. 2-4, catch magnet 120 is disposed proximate arm magnet 112 when arm 105 is in door lock position 130 and catch 110 is in arm lock position 132. In the configuration shown in FIGS. 1-4, catch 110 is biased towards arm release position 133 by the magnetic interaction between arm magnet 112 and catch magnet 120.

In the present example, arm magnet 112 and catch magnet 120 are arranged so that the same magnetic poles are oriented proximate to each other. This arrangement causes arm magnet 112 and catch magnet 120 to magnetically repel each other. When catch 110 is not held in arm lock position 132 by linear actuator 108, arm magnet 112 repels catch magnet 120, which pivots catch 110 towards arm release position 133 shown in FIGS. 3 and 4.

### Linear Actuator

Linear actuator 108 functions to selectively move arm 105 between door lock position 130 and door release position 131. Linear actuator 108 also functions to selectively move catch 110 between arm lock position 132 and arm release position 133. As shown in FIGS. 1-4, linear actuator 108 is disposed proximate to arm 105 and to catch 110.

In the example shown in FIGS. 1-4, linear actuator is a solenoid with a magnetic plunger 118. However, the linear actuator may be any currently known or later developed type of linear actuator in addition to solenoids, such as air cylinders or hydraulic cylinders. In some examples, the linear actuator is not magnetic.

In the present example, linear actuator 108 includes an actuator cylinder 117, a plunger 118, an actuator spring 129, and a press plate 185. Actuator cylinder 117 defines an actuator bore and plunger 118 is moveably disposed in the actuator bore. In the present example, plunger 118 becomes magnetic when selectively energized by the solenoid.

Press plate 185 is mounted to plunger 118 in a position to be engaged by actuator spring 129. In the present example, press plate 185 is a washer mounted to a notch formed on plunger 118, but may be configured differently in other examples.

Actuator spring 129 is mounted on plunger 118 and presses on press plate 185 to move plunger 118 towards engagement member 126. In this manner, actuator spring 129 and press plate 185 cooperate to bias plunger 118 towards arm 105. Plunger 118 overcomes the bias of actuator spring 129 and moves towards system lock position 134 when linear actuator 108 is selectively energized.

Plunger 118 includes a finger 121 extending from a main body portion of plunger 118. Finger 121 extends towards catch 110.

As shown in FIGS. 2-4, linear actuator 108 is configured to move between system lock position 134 and system release position 135. In system lock position 134 shown in FIG. 2, linear actuator 108 restricts catch 110 in arm lock position 132 by engaging catch 110. In particular, finger 121 abuts and presses against catch 110 to restrict catch 110 to arm lock position 132 when linear actuator 108 is in system lock position 134.

As further shown in FIGS. 2 and 3, linear actuator 108 is configured to push arm 105 from arm lock position 132 to arm release position 133 when linear actuator 108 moves between system release position 135 to system lock position 134. In the example shown in FIGS. 1-4, plunger 118 pulls engagement member 126 via magnetic coupling to move arm 105 from arm release position 133 to arm lock position 132.

In system release position 135 shown in FIG. 4, linear actuator 108 allows catch 110 to move to arm release position 133 by retracting finger 121 away from catch 110. Further in system release position 135, plunger 118 presses against engagement member 126 to move arm 105 to door release position 131. Actuator spring 129 moves plunger 118 and finger 121 away from catch 110 towards engagement member 126 when linear actuator is no longer energized to counteract actuator spring 129.

### ADDITIONAL EMBODIMENTS

With reference to FIG. 6, the discussion will now focus on an additional electronic lock system embodiment. The additional embodiment includes many similar or identical features to electronic lock system 100. Thus, for the sake of brevity, each feature of the additional embodiment below will not be redundantly explained. Rather, key distinctions between the additional embodiment and electronic lock system 100 will be described in detail and the reader should reference the discussion above for features substantially similar between the different examples.

### Second Embodiment

Turning attention to FIG. 6, an electronic lock system 200 will now be described. As can be seen in FIG. 6, electronic lock system 200 includes a housing 202 and an electronic lock mechanism 204. A second electronic lock mechanism is not depicted. Electronic lock mechanism 204 includes an arm 205, a catch 210, and a linear actuator 208.

A distinction between electronic lock system 200 and electronic lock system 100 is that catch 210 includes a catch spring 270 not present in catch 110. Catch spring 270 functions to bias catch 210 towards the arm release position depicted in FIG. 6. Catch spring 270 is mounted to housing 202 and pulls catch 210 away from arm 205 when linear actuator 208 selectively moves away from catch 210 to stop pressing catch 210 into the arm lock position. The reader will appreciate that catch spring 270 may supplement or function in place of magnetic repulsion between an arm magnet and a catch magnet.

### Third Embodiment

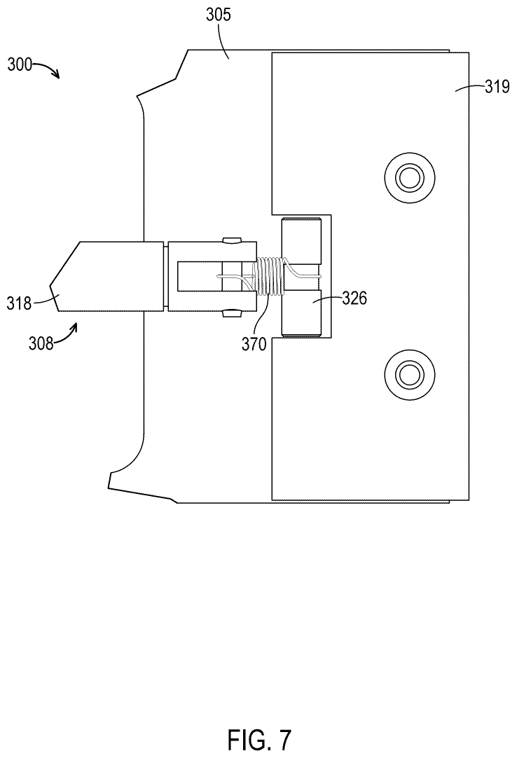

Turning attention to FIG. 7, a portion of an electronic lock system 300 will now be described. The main distinction between electronic lock system 300 and electronic lock system 100 is a spring 370 shown in FIG. 7. Spring 370 is an optional feature not present in all examples of the electronic lock systems described herein.

Spring 370 is mounted to an engagement member 326 of counterweight 319 and to a plunger 318 of linear actuator 308. Spring 370 is an extension spring configured to stretch when arm 305 reaches the end of its travel. Spring 370 allows linear actuator 308 to move to the system lock position to push the catch (not pictured) into the arm lock position.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. An electronic lock system for a door comprising:
a frame; and
an electronic lock mechanism operatively mounted to the frame, the electronic lock mechanism including:
an arm configured to move between a door lock position and a door release position, the arm engaging a door to restrict the door from moving in the door lock position, and the arm being spaced from the door to allow the door to move in the door release position; and
a linear actuator disposed proximate to the arm, the linear actuator configured to move between a system lock position and a system release position, the linear actuator presses against the arm to move the arm to the door release position when the linear actuator is in the system release position.

2. The electronic lock system of claim 1, wherein:
the electronic lock system further comprises a catch disposed proximate to the arm;
the catch is configured to move between an arm lock position and an arm release position;
the catch engages the arm to restrict the arm from moving in the arm lock position;
the catch is spaced from the arm to allow the arm to move in the arm release position;
the linear actuator restricts the catch in the arm lock position by engaging the catch in the system lock position, and the linear actuator allows the catch to move to the arm release position by being spaced from the catch in the system lock position.

3. The electronic lock system of claim 2, wherein the linear actuator is biased towards the system lock position and moves to the system release position when selectively energized.

4. The electronic lock system of claim 3, wherein the linear actuator is configured to pull the arm from the arm release position to the arm lock position when the linear actuator moves between the system release position to the system lock position.

5. The electronic lock system of claim 4, wherein:
the linear actuator is magnetic; and
the linear actuator pulls the arm from the arm lock position to the arm release position via magnetic coupling between the linear actuator and the arm.

6. The electronic lock system of claim 5, wherein:
the linear actuator includes a plunger and the plunger is magnetic;
the arm includes an engagement member disposed proximate to the magnetic plunger when the linear actuator is in the system release position; and
the engagement member is comprised of a magnetically attractable material and magnetically couples to the plunger when the linear actuator is in the system release position.

7. The electronic lock system of claim 6, wherein the plunger is spaced from the engagement member and is magnetically decoupled from the engagement member in the system lock position.

8. The electronic lock system of claim 2, wherein the catch engages the arm in the arm lock position when the arm is in the door lock position.

9. The electronic lock system of claim 2, wherein the catch and the arm are complementarily configured to magnetically interact.

10. The electronic lock system of claim 9, wherein the catch and the arm are complementarily configured to magnetically repel the catch into the arm release position where the catch is spaced from the arm when the catch is not restricted to the arm lock position by the linear actuator.

11. The electronic lock system of claim 2, wherein the catch is biased towards the arm release position.

12. The electronic lock system of claim 11, wherein the electronic lock mechanism further includes a spring configured to pull the catch into the arm release position.

13. The electronic lock system of claim 1, wherein the arm is pivotally mounted to the frame.

14. The electronic lock system of claim 13, wherein:
the electronic lock system further comprises a housing;
the frame is supported in the housing;
the arm includes:
a platform pivotally mounted to the frame; and
a doorstop mounted to the platform;
the doorstop extends beyond the housing to engage the door when the arm is in the door lock position; and
the doorstop retracts into the housing to be spaced from the door when the arm is in the door release position.

15. The electronic lock system of claim 14, wherein:
the arm further includes an engagement member operatively mounted to the platform in a position proximate to the linear actuator; and
the linear actuator presses against the engagement member to pivot the arm to the door release position when the linear actuator is in the system release position.

16. The electronic lock system of claim 15, wherein:
the frame includes an arm bearing shaft;
the arm further includes a counterweight mounted to the platform in a position selected to bias the arm towards the door release position; and
the platform defines an arm bearing port complementarily configured with the arm bearing shaft at a medial position of the platform between the counterweight and the doorstop.

17. The electronic lock system of claim 2, wherein the catch is pivotally mounted to the frame.

18. The electronic lock system of claim 17, wherein the catch includes:
a catch bearing shaft mounted to the frame; and
a catch body having a first end and a second end opposite the first end, the catch body defining:
a catch bearing port proximate the first end and complementarily configured with the catch bearing shaft to receive the catch bearing shaft; and
a notch proximate the second end and complementarily configured with the arm to engage and restrict movement of the arm when the catch is in the arm lock position.

19. The electronic lock system of claim 18, wherein the linear actuator engages the catch body between the bearing port and the second end.

20. The electronic lock system of claim 19, wherein:
the catch further includes a catch magnet mounted to the catch body proximate the second end;
the arm includes an arm magnet disposed proximate to the catch magnet when the arm is in the door lock position and the catch is in the arm lock position; and
the arm magnet and the catch magnet are complementarily configured to magnetically repel each other.
